(19) United States
(12) Patent Application Publication
(10) Pub. No.: US 2009/0088023 A1
(43) Pub. Date: Apr. 2, 2009

(54) Locking Receptacle For Engaging A USB Device

(75) Inventors: Jeremy S. Bridges, Apex, NC (US); Norman B. Desrosiers, Oxford, NC (US); Dean F. Herring, Youngsville, NC (US); Paul J. La Rocca, Rochester, MN (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/862,711

(22) Filed: Sep. 27, 2007

(51) Int. Cl. H01R 13/648

(52) U.S. Cl. 439/607; 439/341

(57) ABSTRACT

A locking receptacle for engaging a USB device is provided. The locking receptacle comprising a four sided header with a top opening at the top of the header and a bottom opening at the bottom of the header, the top opening and the bottom opening for USB connections; the header connected to a pivotable locking tip on one side, the pivotable locking tip located to engage a standard opening on a side of a USB plug of a USB device when the USB plug is fully inserted in the locking receptacle; and the pivotable locking tip connected to a lever for pivoting the locking tip.

### BACKGROUND OF THE INVENTION

1. Field of the Invention

The field of the invention is receptacles for USB devices.

2. Description Of Related Art

Universal Serial Bus (‘USB’) is a serial bus standard to interface devices. USB can connect computer peripherals such as mouse devices, keyboards, PDAs, gamepads and joysticks, scanners, digital cameras and printers. USB was designed to allow peripherals to be connected using a single standardized interface socket to improve plug-and-play capabilities by allowing devices to be connected and disconnected without rebooting the computer. Computers having connected USB peripheral devices may be moved or shipped causing unintentional disconnection of those USB peripheral devices.

### SUMMARY OF THE INVENTION

A locking receptacle for engaging a Universal Serial Bus (‘USB’) device is provided.

The locking receptacle comprising a four sided header with a top opening at the top of the header and a bottom opening at the bottom of the header, the top opening and the bottom opening for USB connections; the header connected to a pivotable locking tip on one side, the pivotable locking tip located to engage a standard opening on a side of a USB plug of a USB device when the USB plug is fully inserted in the locking receptacle; and the pivotable locking tip connected to a lever for pivoting the locking tip.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a cross-sectional view of an embodiment of a locking receptacle for engaging a USB device according to the present invention.

FIG. 2 sets forth a block diagram of a cross-sectional view of an embodiment of a locking receptacle for engaging a USB device according to the present invention in which the pivotable locking tip and the lever are comprised in a single unit separate from the header.

FIG. 3 sets forth a block diagram of a cross-sectional view of an embodiment of a locking receptacle for engaging a USB device according to the present invention in which the separate the single unit is connected to a spring punched in a side of the header.

FIG. 4 sets forth a block diagram of a cross-sectional view of an embodiment of a locking receptacle for engaging a USB device according to the present invention with an alternative the lever configuration.

FIG. 5 sets forth a block diagram of a cross-sectional view of an embodiment of a locking receptacle for engaging a USB device according to the present invention in which the lever and the locking tip are comprised in a separate single unit where the pivotable locking tip and the lever are on opposite sides of the header.

FIG. 6 sets forth a flow chart illustrating an exemplary method for locking a USB device according to the present invention.

### DETAILED DESCRIPTION OF EXEMPLARY EMBODIMENTS

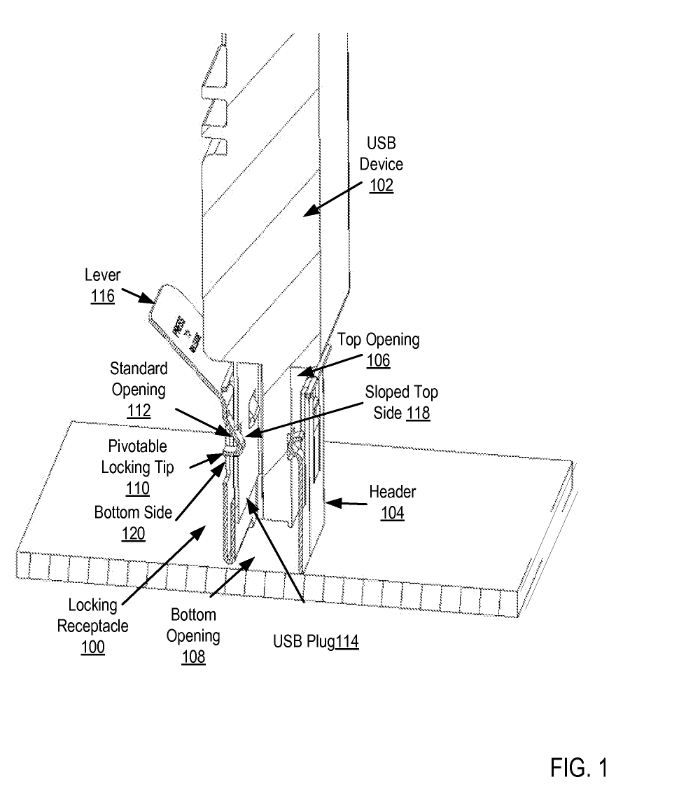

Exemplary locking receptacles for engaging a USB device, methods for locking USB devices and systems for locking USB devices in accordance with the present invention are described with reference to the accompanying drawings, beginning with FIG. 1. FIG. 1 sets forth a block diagram of a cross-sectional view of an embodiment of a locking receptacle (100) for engaging a USB device (102) according to the present invention. The locking receptacle (100) of FIG. 1 is capable of locking a USB device and a computer (not shown) on which the locking receptacle is installed for active USB operations between the computer and the USB device (102).

The USB device (102) of in FIG. 1 is a USB memory stick, often called a keydrive. The example of a USB memory stick in the specification is for example and not for limitation. Examples of USB devices that may be connected to computers through locking receptacles according to the present invention include mouse devices, keyboards, personal digital assistants (‘PDAs’), gamepads and joysticks, scanners, digital cameras, printers and many more as will occur to those of skill in the art.

The locking receptacle (100) of FIG. 1 includes a four sided header (104). The four sided header (104) is sized to receive a USB plug (114) and includes a top opening (106) at the top of the header (104) and a bottom opening (108) at the bottom of the header (104). The top opening (106) and the bottom opening (108) allow for USB connections between the USB device (102) and a computer (not shown) upon which the locking receptacle is installed.

The header (104) of FIG. 1 is connected to a pivotable locking tip (110) on one side. The pivotable locking tip (110) is located to engage a standard opening (112) on a side of a USB plug (114) of a USB device (102) when the USB plug (114) is fully inserted in the locking receptacle (100). USB plugs for USB devices often include two standard openings on one side of the USB plug. In the example of FIG. 1, therefore, there is shown two pivotable locking tips (110) engaged in two standard openings (112) on the side of the USB plug (114) of the USB device (102). While two pivotable locking tips and two standard openings are shown in the example of FIG. 1 only one pivotable locking tip and one standard opening is labeled for clarity of the drawing.

The pivotable locking tip (110) of FIG. 1 is connected to a lever (116) for pivoting the locking tip (110). In the example of FIG. 1 the lever (116) is located near the top of the header (104) and depressing the lever (116) pivots the locking tip (110) to disengage the locking tip (100) from the standard opening (112) in the USB plug (114). Once the locking tip (110) is disengaged from the standard opening (112) a user is free to remove the USB device from the connection with a computer in the typical manner.

In the example of FIG. 1, the pivotable locking tip (110) and the lever (116) are comprised as a part of the header (104). That is, the pivotable locking tip and lever are manufactured into the header of the locking receptacle (100). Such a header may be manufactured of a somewhat bendable metal, somewhat bendable plastic, or other material as will occur to those of skill in the art. The material is typically bendable enough such that the lever may be easily depressed by a user and resilient enough such that the locking tip (110) will to return to its original position when the lever is released.

The locking tip (110) of FIG. 1 has a sloped top side (118). The top side of the locking tip (110) of FIG. 1 is sloped such that force of inserting the USB plug (114) of the USB device (102) in the locking receptacle (100) causes the sloped side of the locking tip to pivot the locking tip thereby allowing the USB plug (114) to be fully inserted into the locking receptacle (100). In response to full insertion of the USB plug (114) the locking tip (110) pivots to engage the standard opening (112) on the side of the USB plug (114).

The locking tip (110) of FIG. 1 has a bottom side (120) that is shaped to engage the standard opening (112) of the USB Plug such that pulling the USB device (102) out o the locking receptacle is made difficult, if not impossible, for most users. Such a shape may be made to be perpendicular to the sides of the header, sloped downward toward the computer or some other shape as will occur to those of skill in the art.

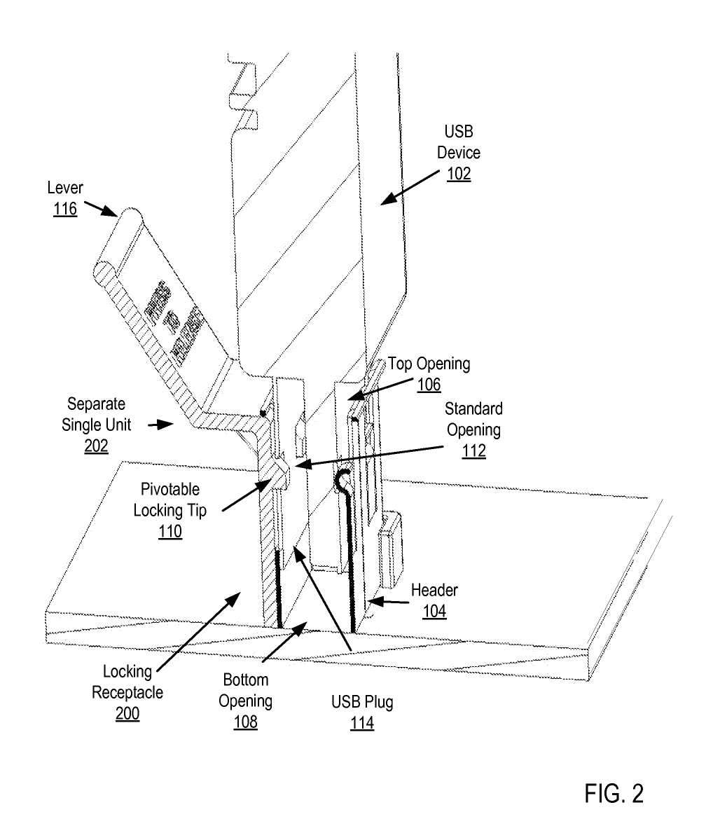

As mentioned above, in the example of FIG. 1, the pivotable locking tip (110) and the lever (116) are comprised as a part of the header (104). The pivotable locking tip (110) and the lever (116) may alternatively be comprised in a single unit (202) separate from the header (104). For further explanation, FIG. 2 sets forth a block diagram of a cross-sectional view of an embodiment of a locking receptacle (200) for engaging a USB device (102) according to the present invention in which the pivotable locking tip (110) and the lever (116) are comprised in a single unit (202) separate from the header (104). The separate single unit (202) of FIG. 2 is connected to the header (104) at the bottom of the header (104). Such a separate single unit may be manufactured of a somewhat bendable metal, somewhat bendable plastic, or other material as will occur to those of skill in the art. The material is typically bendable enough such that the lever may be easily depressed by a user and resilient enough such that the locking tip (110) will to return to its original position when the lever is released.

The separate single unit (202) is connected to the header (104) at the bottom of the header (104) in the example of FIG. 2. This is for example and not for limitation.

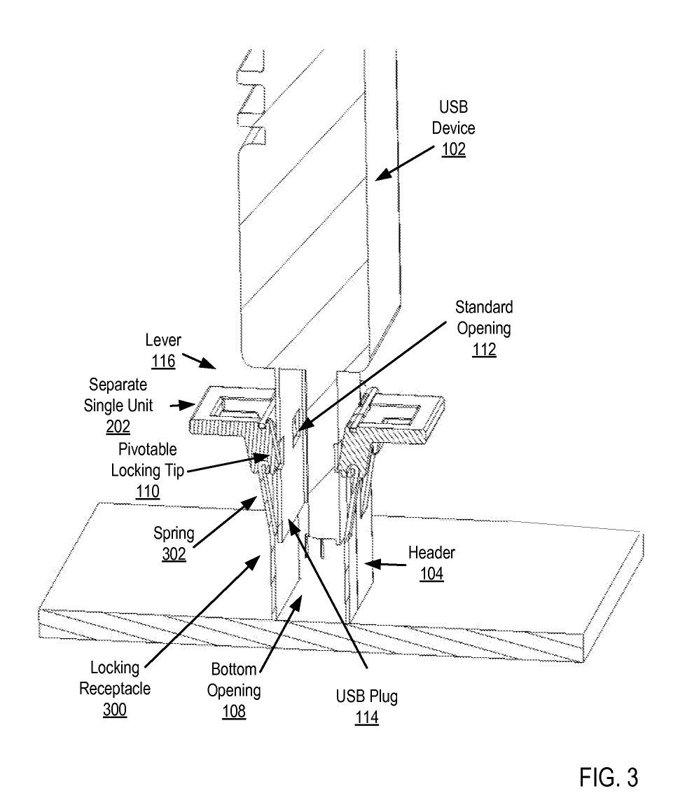

For further explanation, therefore, FIG. 3 sets forth a block diagram of a cross-sectional view of an embodiment of a locking receptacle (300) for engaging a USB device (102) according to the present invention in which the separate the single unit (202) is connected to a spring (302) punched in a side of the header. In the example of FIG. 3 the header is manufactured of a somewhat bendable metal, somewhat bendable plastic, or other material as will occur to those of skill in the art such that the spring may pivot the locking tip and return to its original position when the lever is released.

In the example of FIG. 3 lifting the lever (116) pivots the locking tip (110) by pulling the spring to disengage the locking tip (100) from the standard opening (112) in the USB plug (114). Releasing the lever (116) returns the spring and the locking tip to their original positions.

The example of FIG. 3 illustrates two levers, separate single units, pivotable locking tips, and springs punched on two sides of the header (104). Only one of each of the levers, separate single units, pivotable locking tips, and springs are labeled for clarity of the drawing. In the example of FIG. 3, locking tips engage standard openings on two sides of the USB plug. Removing the USB device of FIG. 3 from the locking receptacle is therefore carried out by lifting both levers (116) thereby pivoting both locking tips (110) by pulling both springs to disengage the locking tips (100) from the standard openings (112) in two sides of the USB plug (114).

The example of 3 illustrates two levers, separate single units, pivotable locking tips, and springs punched on two sides of the header (104) of FIG. 3 is for explanation and not for limitation. In fact, locking receptacles according to the present invention may usefully employ only one lever, separate single unit, pivotable locking tip, and spring similar to those of the example of FIG. 3.

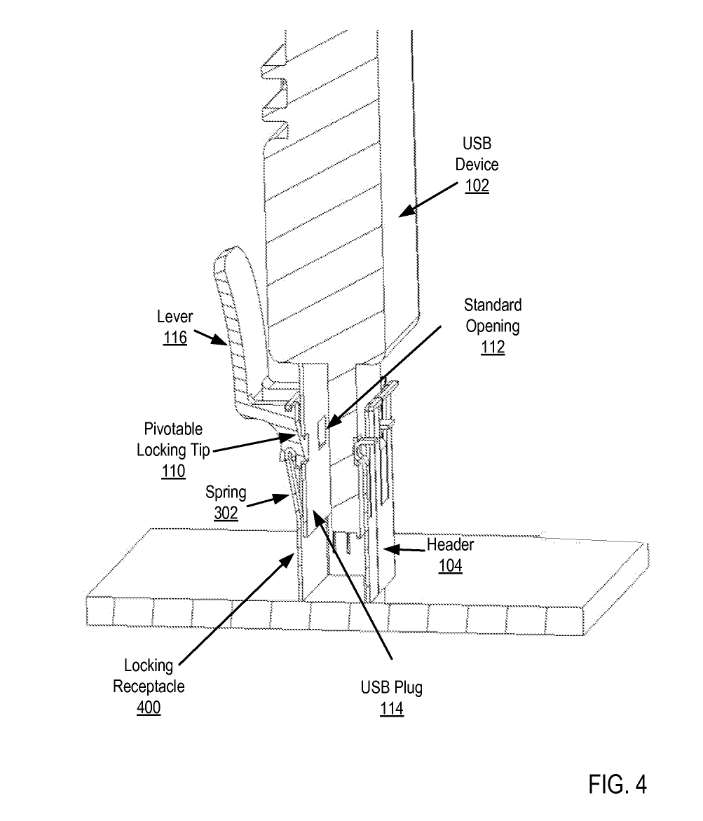

For further explanation, FIG. 4 sets forth a block diagram of a cross-sectional view of an embodiment of a locking receptacle (400) for engaging a USB device (102) according to the present invention with an alternative the lever (116) configuration. In the example of FIG. 4, the pivotable locking tip (110) is connected to a spring (302) punched in the side of the header (104). In the example of FIG. 4, moving the lever (116) toward the USB device (102) pivots the locking tip (110) by bending the spring (302) to disengage the locking tip (100) from the standard opening (112) in the USB plug (114). The lever configuration of the exemplary locking receptacle (400) of FIG. 4 facilitates a user moving the lever and removing the USB devices with a single hand.

Alternatively, embodiments of locking receptacles for engaging a USB devices according to the present invention may include lever configurations in which moving the lever away from the USB device pivots the locking tip to disengage the locking tip from the standard opening in the USB plug.

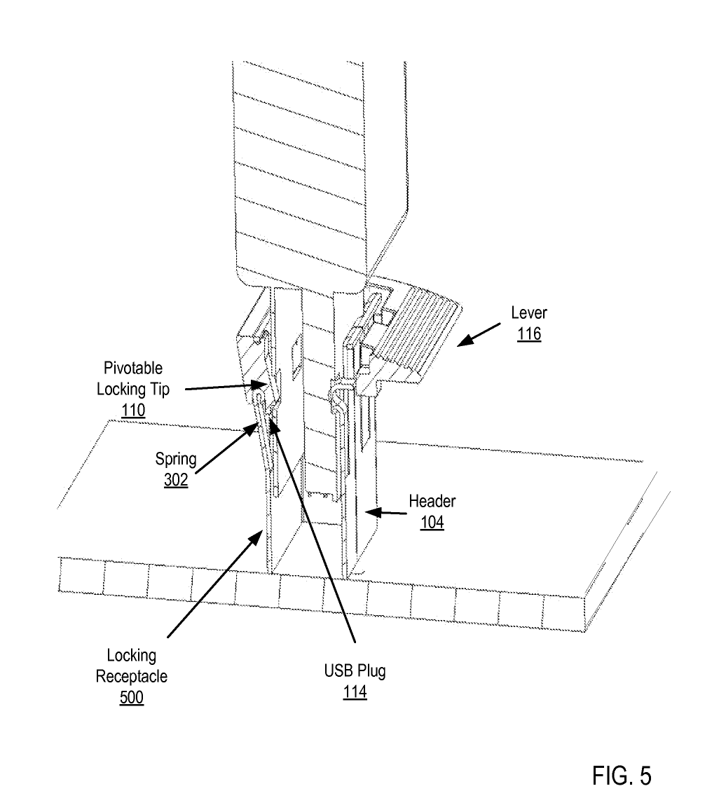

In the examples of FIGS. 1-4, the locking receptacle had a locking tip on the same side of the header as the lever for pivoting that locking tip. For further explanation, FIG. 5 sets forth a block diagram of a cross-sectional view of an embodiment of a locking receptacle (500) for engaging a USB device (102) according to the present invention in which the lever (116) and the locking tip (110) are comprised in a separate single unit where the pivotable locking tip (110) and the lever (116) are on opposite sides of the header (104). In the example of FIG. 5, the locking tip (110) is connected to a spring (302) punched in the side of the header (104). In the example of FIG. 5, depressing the lever (116) pivots the locking tip (110) by bending the spring (302) to disengage the locking tip (100) from the standard opening (112) in the USB plug (114).

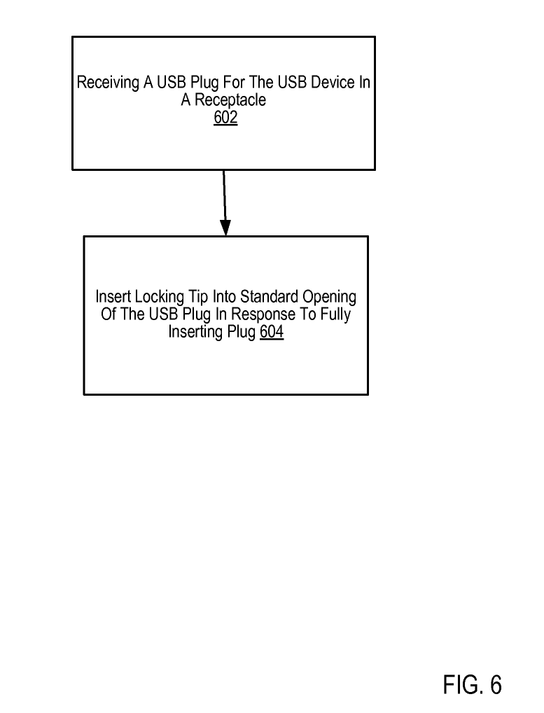

For further explanation, FIG. 6 sets forth a flow chart illustrating an exemplary method for locking a USB device according to the present invention. The method of FIG. 6 includes receiving (602) a USB plug of the USB device in a receptacle. Receiving (602) a USB plug of the USB device in a receptacle may be carried out by providing a receptacle capable of having inserted into it a USB plug.

In response to receiving the USB plug of the USB device in the receptacle such that the USB plug is fully inserted in the receptacle, the method of FIG. 6 includes inserting a locking tip into a standard opening on the side of the USB plug. Inserting a locking tip into a standard opening on the side of the USB plug may be carried out by a releasing a bent locking tip, releasing a spring punched in the side of the receptacle, and in other ways as will occur to those of skill in the art.

A system for locking a USB device is also provided. Embodiments include means for receiving a USB plug of the USB device in a receptacle; and means for inserting a locking tip into a standard opening on the side of the USB plug in response to receiving the USB plug of the USB device in the receptacle such that the USB plug is fully inserted in the receptacle. Means for receiving a USB plug of the USB device in a receptacle may include a header with a top opening and a bottom opening for USB connections, an opening in the receptacle itself, a clip for receiving the USB device in the receptacle of any other means for receiving a USB plug of the USB device in a receptacle that will occur to those of skill in the art. Means for inserting a locking tip into a standard opening on the side of the USB plug in response to receiving the USB plug of the USB device in the receptacle such that the USB plug is fully inserted in the receptacle may include a bendable locking tip, a spring punched in the side of a header of USB receptacle, a rotate-able engagement, or any other means for inserting a locking tip that will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A locking receptacle for engaging a Universal Serial Bus (‘USB’) device, the locking receptacle comprising:
a header with a top opening at the top of the header and a bottom opening at the bottom of the header, the top opening and the bottom opening for USB connections;
the header connected to a pivotable locking tip on one side, the pivotable locking tip located to engage a standard opening on a side of a USB plug of a USB device when the USB plug is fully inserted in the locking receptacle;
the pivotable locking tip connected to a lever for pivoting the locking tip.

2. The locking receptacle of claim 1 wherein the lever is located near the top of the header and depressing the lever pivots the locking tip to disengage the locking tip from the standard opening in the USB plug.

3. The locking receptacle of claim 2 wherein the pivotable locking tip and the lever are comprised as a part of the header.

4. The locking receptacle of claim 2 wherein the pivotable locking tip and the lever are comprised in a single unit separate from the header.

5. The locking receptacle of claim 4 wherein the single unit is connected to the header at the bottom of the header.

6. The locking receptacle of claim 2 wherein the single unit is connected to a spring punched in a side of the header.

7. The locking receptacle of claim 6 wherein lifting the lever pivots the locking tip to disengage the locking tip from the standard opening in the USB plug.

8. The locking receptacle of claim 6 wherein depressing the lever pivots the locking tip to disengage the locking tip from the standard opening in the USB plug.

9. The locking receptacle of claim 6 wherein moving the lever toward the USB device pivots the locking tip to disengage the locking tip from the standard opening in the USB plug.

10. The locking receptacle of claim 6 wherein moving the lever away from the USB device pivots the locking tip to disengage the locking tip from the standard opening in the USB plug.

11. The locking receptacle of claim 1 wherein the locking tip has a sloped top side.

12. A method for locking a Universal Serial Bus (‘USB’) device, the method comprising:
receiving a USB plug of the USB device in a receptacle; and
in response to receiving the USB plug of the USB device in the receptacle such that the USB plug is fully inserted in the receptacle, inserting a locking tip into a standard opening on the side of the USB plug.

13. A system for locking a Universal Serial Bus (‘USB’) device, the system comprising:
means for receiving a USB plug of the USB device in a receptacle; and
means for inserting a locking tip into a standard opening on the side of the USB plug in response to receiving the USB plug of the USB device in the receptacle such that the USB plug is fully inserted in the receptacle.
